(19) United States
(12) Patent Application Publication
(10) Pub. No.: US 2006/0071630 A1
(43) Pub. Date: Apr. 6, 2006

(54) Hybrid power system

(75) Inventors: Mark Dame, Niskayuna, NY (US); Michael Durling, Gansevoort, NY (US); William H. Girodet, Palm Beach Gardens, FL (US)

Correspondence Address: Paul J. Esatto, Jr.;Scully, Scott, Murphy & Presser, 400 Garden City Plaza, Garden City, NY, 11530, US

(73) Assignee: Lockheed Martin Corporation, Bethesda, MD (US)

(21) Appl. No.: 10/951,251

(22) Filed: Sep. 27, 2004

(51) Int. Cl. H02J 7/00

(52) U.S. Cl. 320/104

(57) ABSTRACT

A hybrid power/propulsion system for a vehicle is provided that combines a fuel cell with a battery. A fuel cell, which uses a hydrogen and oxygen supply in fluid communication with the fuel cell, is combined with a battery system for power generation for a vehicle. The fuel cell is used when a low power is required by the vehicle, and the fuel cell is used in combination with the battery system when high power is required by the vehicle. The vehicle can be a land or marine vehicle, which can be a surface vessel or underwater vehicle.

### BACKGROUND OF THE INVENTION

1. Field of the Invention

The present invention relates to power generation systems for marine and land vehicles, and more specifically, to an invention capable of combining battery power with a rechargeable fuel cell system for a hybrid power and propulsion generation system for marine and land vehicles.

2. Prior Art

Vehicles that operate underwater are useful for performing tasks below the sea surface in such fields as deep-water salvage operations, navy and marine operations, underwater telecommunications, offshore petroleum and mining, and oceanographic research. Many of these applications are completed by small-scale underwater vehicles that can be either manned or unmanned (remotely operated). The unmanned vehicles are commonly known as Unmanned Underwater Vehicles (UUVs).

Generally, these small-scale underwater vehicles have used conventional power systems. These conventional power/propulsion generation systems for underwater vehicles have been limited to electrochemical systems, which have provided low speed operation of the underwater vehicles. Current power/propulsion technology for underwater vehicles do not have the capacity to provide the sustained high power required by the next generation of underwater vehicles.

For example, power in a manned or unmanned underwater vehicle typically comes from an on-board power supply such as a battery. Because this on-board power supply has a limited propulsion capacity, tasks requiring a quick getaway in which a vehicle needs a sustained high velocity escape from an undesirable situation (i.e. encounter with the enemy), are not attainable using the conventional power/propulsion generation systems.

Long duration underwater missions require large amounts of neutrally buoyant electrically rechargeable energy storage. Traditionally, these underwater vehicles traveled slowly and quietly at low power levels to conserve energy and go undetected by the enemy. If the vehicle is detected, a high power and speed mode is desired for a quick get away.

Traditional marine propulsion systems generally include an energy source, such as a battery or AC generator, a power conversion means for converting the current output of the energy source, an electric motor, a coupling system for transferring the motor output, which includes shafts, bearings and linkages, a propulsor for imparting thrust to the vehicle, and a cooling system for removing waste heat from the assembly. The cooling system typically includes a circulation pump, a heat exchanger and piping.

Examples of such conventional propulsion systems can be found in U.S. Pat. No. 5,702,273 and U.S. Pat. No. 4,424,042. These patents provide propulsion systems for underwater vehicles. However, these propulsion systems are powered by A.C. power sources and conventional battery systems, and such conventional propulsion systems do not provide for a sustained high power when the marine vehicles require a high speed in certain situations. Similarly, land vehicles can also use a high speed in similar situations encountered on land.

### SUMMARY OF THE INVENTION

Therefore, it is an object of the present invention to provide a vehicle capable of providing both power for low-speed, stealthy operations, and a high-power option when high speed is required.

Accordingly, an apparatus for a hybrid power generation system that provides for a high power in a vehicle is provided. The apparatus for a hybrid power generation system comprises a fuel cell for powering the vehicle when a low power is required by the vehicle, and a battery for powering the vehicle in combination with the fuel cell when a high power is required by the vehicle.

The apparatus for a hybrid power generation system further comprises an oxygen supply and a hydrogen supply, where oxygen is injected from the oxygen supply and hydrogen is injected from the hydrogen supply into the fuel cell when a low power is required by the vehicle. The fuel cell generates electricity for a motor drive that drives a propulsion system for the vehicle when a low power is required, and the battery and the fuel cell generate electricity for the motor drive when a high power is required.

The apparatus for a hybrid power generation system further comprises a water supply in which water formed by the fuel cell is stored therein, and an electrolyzer that reduces the water in the water supply into hydrogen and oxygen. The hydrogen is stored in a hydrogen supply and the oxygen is stored in an oxygen supply. The electrolyzer is powered by an off board power supply. The vehicle can be an underwater vehicle or a land vehicle, which can either be manned or unmanned.

Further, a hybrid power generation method for a vehicle is provided comprising powering a motor of the vehicle by a fuel cell when a low power is required by the vehicle, and powering a motor of the vehicle by a battery in combination with the fuel cell when a high power is required by the vehicle.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematic representation of a power system for carrying out an implementation of the present invention.

FIG. 2 illustrates a schematic representation of recharging the power system of FIG. 1.

### DETAILED DESCRIPTION OF THE INVENTION

Although this invention is applicable to numerous and various types of power generation and propulsion systems for vehicles, it has been found particularly useful in the environment of power generation systems for ground vehicles (electric automobiles), pollution free surface vessels (ships and boats), and small-scale underwater vehicles, such as UUVs. Therefore, without limiting the applicability of the invention to the above, the invention will be described in such environment.

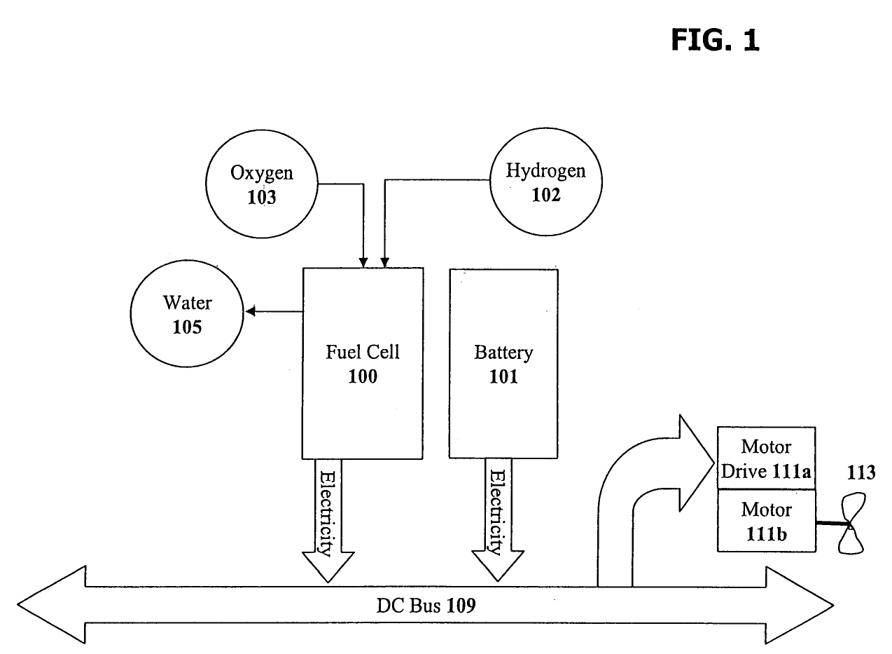

With reference to FIG. 1, there is a schematic representation of a hybrid power/propulsion generation system. Hydrogen is stored in a hydrogen supply 102 and oxygen is stored in an oxygen supply 103. The hydrogen supply 102 and oxygen supply 103 could be pressurized tanks containing the fuel and oxidizer, respectively, with the related control and safety elements. The hydrogen supply 102 and the oxygen supply 103 are in fluid communication with a fuel cell 100. Water is initially stored in a water supply 105, which is in fluid communication with the fuel cell 100.

The hydrogen and oxygen gases stored in the hydrogen supply 102 and the oxygen supply 103, respectively, are the reactants for the fuel cell 100. The appropriate amounts of oxygen and hydrogen are injected into the fuel cell 100 from the hydrogen supply 102 and the oxygen supply 103 depending on the power required. An appropriate control system can regulate the amount of hydrogen and oxygen injected into the fuel cell 100 based on the requirement. The hydrogen and oxygen flow into the fuel cell 100, which produces direct current electricity and water.

The electricity from the fuel cell 100 is provided to a DC bus 109, which is used to power the motor drive 111a. The motor drive 111a converts the direct current from the DC bus 109 to alternating current for the motor 111b. DC motors can also be used. The motor 111b drives the power/propulsion system 113 of the vehicle. The water from the fuel cell 100 is stored in the water supply 105 for later conversion back into H₂ and O₂.

The battery 101 can also provide electricity to the DC bus 109. Electricity from the battery 101 can be fed to the DC bus 109 to the motor drive 111a. The motor drive 111a converts the direct current from the DC bus 109 to alternating current for the motor 111b, which can drive the power/propulsion system 113 of the vehicle. AC-DC converters and the battery 101 can be used to minimize the voltage swing on the DC bus 109.

The fuel cell 100 can operate independently of the battery 101 when the vehicle is in cruise mode. The cruise mode requires low power for a long duration, so it is a low power, high energy mode. When the vehicle is in a sprint mode, the fuel cell 100 can operate simultaneously with the battery 101. The sprint mode requires a large amount of power for a short duration of time, thus making it a high power, low energy mode. The fuel cell 100 is used by the vehicle for operational modes requiring low power, and the battery 101 is used by the vehicle in combination with the fuel cell 100 for operational modes requiring high power. The fuel cell 100 continues to operate at all times to provide the basic minimum power required by the vehicle.

When the vehicle requires a low power, then the fuel cell 100 provides electrical power to DC bus 109, which provides direct current to the motor drive 111a. The motor drive 111a converts the direct current to alternating current for the motor 111b, which drives the power/propulsion system 113 of the vehicle. When the vehicle requires a high power, then the fuel cell 100 will operate at its maximum power and the battery 101 will supplement the fuel cell 100 during high power operation. Electrical power is provided by both the fuel cell 100 and the battery 101 to the DC bus 109, which is supplied to the motor drive 111a. The motor drive 111a converts the direct current to alternating current for the motor 111b, which runs the power/propulsion system 113 when a high speed is required. Low power can be used when a low speed is required, while a high power can be used when a high speed is required.

The dual power systems allow for both normal power levels and boost or high-load conditions. The two power cycles provide very different power outputs. The fuel cell 100 provides nominal steady power when the vehicle requires a low speed for base-load applications. The battery 101 provides high power output for short periods of time when the vehicle requires a high speed, by supplementing the fuel cell when a high speed is required.

This system is more efficient than standard combustion reaction systems, thus providing a more efficient power/propulsion generation system. The coupling of the regenerative fuel cell 100 and the battery 101 provides for nominal steady state power when nominal power is required, by using the power in the fuel cell 100, and provides for instantaneous high power when a high power is required, by using the hybrid power of the battery 101 and fuel cell 100.

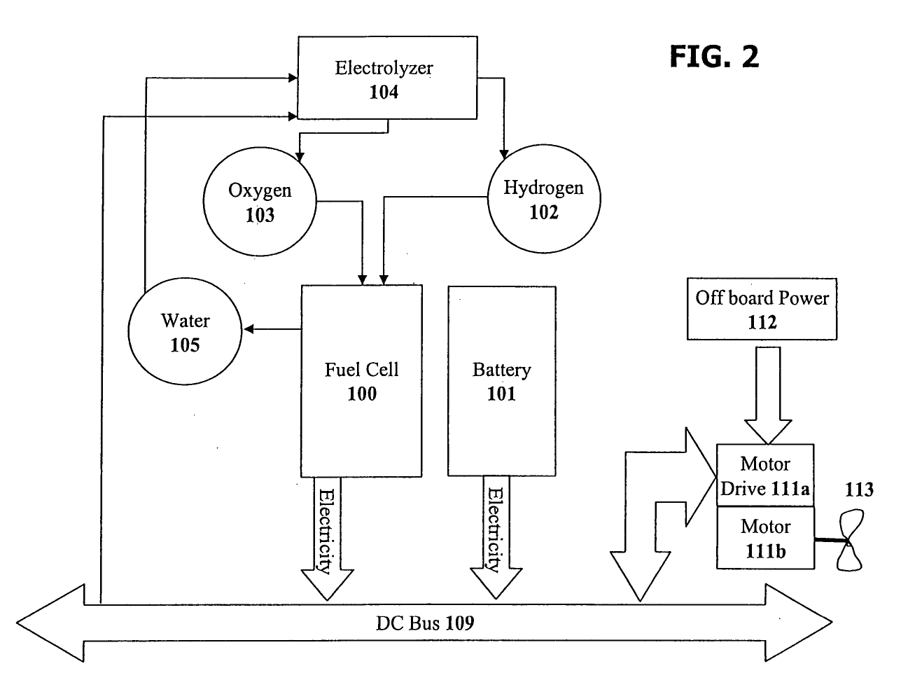

As shown in FIG. 2, the stored water in the water tank 105 can be converted back into H₂ and O₂ by running the electrolyzer 104, which would require electrical power be fed by an outside or off board power supply 112. An external power source such as the off board power supply 112 is used to feed electricity (alternating current) into the motor drive 111a. The motor drive 111a converts the alternating current from the off board power supply 112 to direct current, which is fed to DC bus 109. DC bus 109 supplies direct current to the electrolyzer 104, and the electrolyzer 104 can reduce the water from the water tank 105 back into hydrogen and oxygen. This hydrogen and oxygen are stored in the hydrogen tank 102 and the oxygen tank 103, respectively. Thus, this is a regenerative system, in which an external power source is used to re-charge the fuel cell 100.

Thus, the system only requires an electrical connection to regenerate the fuel supply. Therefore, a simple electrical connection is able to refuel the vehicle (by breaking down the water in the water supply 105 into hydrogen and oxygen), and it does not require any additional fuel. Preferably, the electrolyzer is stored on the vehicle. Thus, when a vehicle such as a car or UUV returns from a trip, a simple connection to an outside or off board power supply 112 can recharge the power system of the vehicle.

The present invention provides several advantages that solves the problems with prior art methods. It provides nominal steady power when the vehicle requires a low speed, or a high power when the vehicle requires a high speed, by using the fuel cell when a low speed is required, and using the battery in combination with the fuel cell when a high speed is required.

The above description of the present invention is only one embodiment of the invention. Various other combinations of vehicles are also possible, in which the vehicle can be either manned or unmanned, be a land or marine vehicle, which can either be a surface vessel such as a ship or boat, or an underwater vehicle. Further, a single battery may be used as battery 101 or multiple battery packs may be used as the battery 101. One or more fuel cells may be used as well. Different numbers of electrolyzers and motors can be used depending on the power required and on the amount of fuel cells and batteries used.

A fuel cell bank can be used, which can comprise two or more fuel cells. The fuel cell bank can provide electricity to more than one motor, when a low power is required by the vehicle. A battery bank can be used, which can comprise two or more battery energy systems in combination with a fuel cell bank when a high power is required by the vehicle. The battery bank can generate electricity for more than one motor in combination with the fuel cell bank when the vehicle is in sprint mode and requires a high speed (high power).

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. An apparatus for a hybrid power generation system for a vehicle comprising:
a fuel cell for powering said vehicle when low power is required by said vehicle; and
a battery for powering said vehicle in combination with said fuel cell when high power is required by said vehicle.

2. The apparatus for a hybrid power generation system of claim 1, further comprising an oxygen supply and a hydrogen supply.

3. The apparatus for a hybrid power generation system of claim 2, wherein oxygen is injected from said oxygen supply and hydrogen is injected from said hydrogen supply into said fuel cell when said low power is required by said vehicle.

4. The apparatus for a hybrid power generation system of claim 1, wherein said fuel cell generates electricity for a motor that drives a power or propulsion system for said vehicle when said low power is required.

5. The apparatus for a hybrid power generation system of claim 1, wherein said battery and said fuel cell generate electricity for a motor that drives a power or propulsion system for said vehicle when said high power is required.

6. The apparatus for a hybrid power generation system of claim 1, further comprising a water supply in which water formed by said fuel cell is stored therein.

7. The apparatus for a hybrid power generation system of claim 6, further comprising an electrolyzer that reduces the water in said water supply into hydrogen and oxygen.

8. The apparatus for a hybrid power generation system of claim 7, wherein said hydrogen is stored in a hydrogen supply and said oxygen is stored in an oxygen supply.

9. The apparatus for a hybrid power generation system of claim 1, wherein said fuel cell is recharged by an outside or off board power supply.

10. The apparatus for a hybrid power generation system of claim 1, wherein said vehicle is an underwater vehicle, which can be either manned or unmanned.

11. The apparatus for a hybrid power generation system of claim 1, wherein said vehicle is a marine vessel, which can be either manned or unmanned.

12. The apparatus for a hybrid power generation system of claim 1, wherein said vehicle is a land vehicle, which can be either manned or unmanned.

13. A hybrid power generation method for a vehicle, the method comprising:
powering a motor of said vehicle by a fuel cell when low power is required by said vehicle; and
powering a motor of said vehicle by a battery in combination with said fuel cell when high power is required by said vehicle.

14. The hybrid power generation method of claim 13, wherein the step of powering said motor of said vehicle when said low power is required comprises injecting oxygen from an oxygen supply and hydrogen from a hydrogen supply into said fuel cell.

15. The hybrid power generation method of claim 13, further comprising generating electricity by said fuel cell for a motor that drives a power or propulsion system for said vehicle when said low power is required.

16. The hybrid power generation method of claim 13, further comprising generating electricity by said battery and said fuel cell for a motor that drives a power or propulsion system for said vehicle when said high power is required.

17. The hybrid power generation method of claim 13, further comprising storing water formed by said fuel cell in a water supply.

18. The hybrid power generation method of claim 17, further comprising reducing the water in said water supply into hydrogen by an electrolyzer.

19. The hybrid power generation method of claim 18, further comprising storing said hydrogen in a hydrogen supply and storing said oxygen in an oxygen supply.

20. The hybrid power generation method of claim 13, further comprising recharging said fuel cell by an outside or off board power supply.
